(19) United States
(12) Patent Application Publication
(10) Pub. No.: US 2025/0150313 A1
(43) Pub. Date: May 8, 2025

(54) Techniques for increasing randomness among the communication lanes of a multilane wired data communication link

(71) Applicant: HUAWEI TECHNOLOGIES CO., LTD., Shenzhen (CN)

(72) Inventor: Sujan Pandey, Munich (DE)

(73) Assignee: HUAWEI TECHNOLOGIES CO., LTD., Shenzhen (CN)

(21) Appl. No.: 19/011,048

(22) Filed: Jan. 6, 2025

Related U.S. Application Data
(63) Continuation of application No. PCT/EP2022/068728, filed on Jul. 6, 2022.

(51) Int. Cl. H04L 25/03

(52) U.S. Cl. CPC H04L 25/03866; H04L 2025/03363

(57) ABSTRACT

The present disclosure relates to an apparatus for increasing randomness among different communication lanes of a multilane wired data communication link. The apparatus comprises a multilane data transmitter configured to simultaneously transmit data over a first communication lane and a second communication lane of the multilane wired data communication link. The apparatus comprises a set of data scramblers configured to scramble the data before transmission by the multilane data transmitter. A first data scrambler is configured to scramble data starting with a first seed signal specifying an initial state of the first data scrambler. A second data scrambler is configured to scramble data starting with a second seed signal specifying an initial state of the second data scrambler. The first seed signal and the second seed signal differ from each other by a predetermined signal distance measure that increases the randomness among the data from the set of data scramblers.

### CROSS-REFERENCE TO RELATED APPLICATIONS

This application is a continuation of International Application No. PCT/EP2022/068728, filed on Jul. 6, 2022, the disclosure of which is hereby incorporated by reference in its entirety.

### TECHNICAL FIELD

The present disclosure relates to high speed wired communication PHY (Physical layer device) technology and multilane transmission for high bandwidth applications, in particular for automotive applications. The disclosure particularly relates to techniques for increasing randomness among the communication lanes of a multilane wired data communication link. More particularly, the disclosure relates to scramblers for high bandwidth transmission and scrambler seeds initialization to achieve better data randomization.

### BACKGROUND

Multilane high speed wired communication PHY technology uses more than one lane to transmit data simultaneously, in order to satisfy an increasing bandwidth demand, e.g., for automotive applications. All existing technologies that are based on multilane communication use higher order polynomial scrambler, in order to make sure that there is no data correlation among the lanes. This is important for cancelling the unavoidable crosstalk that happens among the lanes. Recently, IEEE 802.3cy standard for automotive adopted 33-bit scrambler with scrambler period of 0.6 sec. The multilane PHY technology will deploy maximum of four lanes to achieve 100 Gbit/s data rate and will duplicate the same 33-bit scrambler for all lanes. Given the shorter scrambler period, the data stream from each lane will be correlated as shown in FIG. 1, since they are using the same 33-bits scrambler with relatively shorter scrambler period. In this situation with data streams which are highly correlated, it is virtually impossible to cancel the crosstalk at the receiver. Instead, extremely high order polynomial scramblers can be used to get rid of data correlation issue among the lanes. Earlier results, however, clearly illustrated that such higher order polynomial-based scrambler results in poor emission behavior. Thus, it is an interest to keep the order of polynomial moderate and look for options to improve the scrambler behavior that sufficiently randomize the data stream among the lanes.

### SUMMARY

The present disclosure provides a solution for overcoming the above-described crosstalk issues in multilane high speed wired data communication. In particular, a solution for increasing randomness among the communication lanes of a multilane wired data communication link is presented.

The disclosure presents a concept for reducing the above-described crosstalk issues by improving the randomness among the communication lanes of a multilane wired data communication link.

It is important to maintain the sufficient randomization of data stream among multiple lanes, in order to eliminate the crosstalk noise at the receiver. However, a relatively low order scrambler polynomial cannot guarantee this for all scenarios. Thus, a scrambler seeds initialization technique is presented in this disclosure to make sure that those seeds have enough distance with respect to each other (“are sitting far apart”) and the resulting data streams from those scramblers are sufficiently randomized. This initialization can be done at the beginning of link start-up so that phase difference among the scramblers is maintained all the time.

The main points of this new randomization concept can be described as follows:
a) Initializing known scrambler seed of a set of scramblers at the beginning of communication process between two PHYS;
b) Make sure that the value of seeds and their location result is maximizing the data randomization among the output of scramblers;
c) The distance (phase) separation of scrambler's seeds depends on the number of communication lanes;
d) For instance, if there are two lanes then scrambler's seeds need to be 180 degrees phase apart ideally. If there are four lanes then a set of scrambler's seeds needs to be 90 degrees phase apart ideally.

The concept described in this disclosure can be applied in automotive applications using multilane data communication. Multilane transmission may be implemented by shielded cables or unshielded cables, by twisted pair cable or by coaxial cables. The concept described herein may be applied in PHY technology standards such as the IEEE 802.3 series, e.g., 1000BASE-T, 2.5GBASE-T, 5GPASE-T, 10GBASE-T, and 40GBASE-T, in particular for the multilane standards 50GBASE-T2 (2 lanes) and 100GBASE-T4 (4 lanes).

The technology described in this disclosure can be used as a standard using the disclosed randomization and initialization concept for scramblers as defined within IEEE 802.3 standardization.

Apart from automotive, the technology described herein can also be applied in industrial and automation applications, in automotive in-vehicle networking, avionics, control and automation, etc.

The disclosed technique achieves better randomization data among different lanes so that crosstalk cancellation can be easily performed. Further, keeping a rather short period scrambler, the emission limit can be kept well under control.

According to a first aspect, the disclosure relates to an apparatus for increasing randomness among different communication lanes of a multilane wired data communication link, the apparatus comprising: a multilane data transmitter configured to simultaneously transmit data over a first communication lane and a second communication lane of the multilane wired data communication link; and a set of data scramblers configured to scramble the data before transmission by the multilane data transmitter, wherein a first data scrambler of the set of data scramblers is assigned to scramble data for transmission over the first communication lane and wherein a second data scrambler of the set of data scramblers is assigned to scramble data for transmission over the second communication lane; wherein the first data scrambler is configured to scramble data starting with a first seed signal specifying an initial state of the first data scrambler, wherein the second data scrambler is configured to scramble data starting with a second seed signal specifying an initial state of the second data scrambler, wherein the first seed signal and the second seed signal differ from each other by a predetermined signal distance measure that increases the randomness among the data from the set of data scramblers.

Such an apparatus allows to sufficiently increase randomness among the different communication lanes of the multilane wired data communication link. This means that crosstalk can be efficiently cancelled or at least significantly reduced at the receiver. This allows data transmission at higher data rates, since crosstalk is reduced, thereby not disturbing signal reconstruction at the receiver.

The predetermined signal distance measure can be predetermined in such a way that it gives an optimal or maximum randomness among the data from the set of data scramblers.

Such an increase of randomness among the different communication lanes helps to maximize the crosstalk mitigation at the receiver.

In an exemplary implementation of the apparatus, the first seed signal and the second seed signal are predefined based on the predetermined signal distance measure.

This provides the advantage that based on this knowledge, the receiver can optimally descramble the scrambled data. The predefined signal distance measure enables a sufficient or even optimal randomness between the different communication lanes such that crosstalk can be detected at the receiver and optimally resolved by the receiver.

In an exemplary implementation of the apparatus, the signal distance measure is predetermined in order to enable a data randomization among the communication lanes of the multilane data transmitter in order to minimize or at least reduce an effect of crosstalk or/and if needed to mitigate crosstalk through cancellation at a receiver.

This provides the advantage that there is enough data randomization among the communication lanes of the multilane data transmitter. The effect of crosstalk can be reduced. If needed crosstalk can be cancelled or mitigated by the receiver.

In an exemplary implementation of the apparatus, each data scrambler of the set of data scramblers comprises a linear feedback shift register and a scrambler polynomial defining an exclusive OR operation on the linear feedback shift register, wherein each linear feedback shift register is initialized by a corresponding seed signal before the multilane wired data communication link is initialized.

This provides the advantage that the linear feedback shift registers do not operate with the same seed signal, but they have different seed signals providing enough randomization between the scrambled data. Thus, the crosstalk effect can be reduced.

In an exemplary implementation of the apparatus, the first seed signal is associated with an initial state of a first linear feedback shift register and the second seed signal is associated with an initial state of a second linear feedback shift register, wherein the predetermined signal distance measure is based on a Hamming distance with respect to the initial states of the first linear feedback shift register and the second linear feedback register.

This provides the advantage that the seed signals can be represented by their initial states. Hence, the seed signals can be easily implemented as bytes or words which are designed to be separated by a Hamming distance. It understands that any other suitable metric can be used for separating the initial states.

In an exemplary implementation of the apparatus, the first seed signal and the second seed signal have different phases, the phases being predefined according to the predetermined signal distance measure.

This provides the advantage that the different phases can be easily illustrated by a phase diagram where the different phases are depicted over the scrambler period.

In an exemplary implementation of the apparatus, the phase difference between the first seed signal and the second seed signal is based on a number of communication lanes of the multilane data transmitter.

This provides the advantage that a maximum distance can be applied for each seed signal.

In an exemplary implementation of the apparatus, the phase difference between the first seed signal and the second seed signal lies within a threshold range around 360 degrees divided by the number of communication lanes, wherein the 360 degrees correspond to a period of the data scramblers of the set of data scramblers.

This provides the advantage that the value of 360°/(number of communication lanes) specifies the maximum distance between the seed signals. However, not only the exact values are required, also deviations from the exact values still provide enough randomization between the communication lanes.

In an exemplary implementation of the apparatus, for a four-lane wired data communication link, a first seed signal of a first data scrambler associated with a first communication lane of the four-lane data transmitter corresponds to a phase of 45 degrees or a phase within a threshold range around 45 degrees, a second seed signal of a second data scrambler associated with a second communication lane of the four-lane data transmitter corresponds to a phase of 135 degrees or a phase within a threshold range around 135 degrees, a third seed signal of a third data scrambler associated with a third communication lane of the four-lane data transmitter corresponds to a phase of 225 degrees or a phase within a threshold range around 225 degrees, a fourth seed signal of a fourth data scrambler associated with a fourth communication lane of the four-lane data transmitter corresponds to a phase of 315 degrees or a phase within a threshold range around 315 degrees.

This design for a four-lane wired data communication link provides the best randomization between the four communication lanes.

In an exemplary implementation of the apparatus, for a two-lane wired data communication link, a first seed signal of a first data scrambler associated with a first communication lane of the two-lane data transmitter corresponds to a phase of 90 degrees or a phase within a threshold range around 90 degrees, a second seed signal of a second data scrambler associated with a second communication lane of the two-lane data transmitter corresponds to a phase of 270 degrees or a phase within a threshold range around 270 degrees.

This design for a two-lane wired data communication link provides the best randomization between the two communication lanes.

In an exemplary implementation of the apparatus, the set of data scramblers is configured to decorrelate the data of the different communication lanes of the multilane wired data communication link.

This provides the advantage that data of the different communication lanes is efficiently decorrelated in order to provide enough randomization between the communication lanes for efficient reduction or cancellation of crosstalk at the receiver.

In an exemplary implementation of the apparatus, the set of data scramblers comprises self-synchronizing data scramblers which are configured to scramble the data without knowledge of a frame synchronization of the data.

This provides the advantage that no frame synchronization of the data is required and the scrambling process is easy and fast.

In an exemplary implementation of the apparatus, the multilane data transmitter is configured to transmit data according to 50GBASE-T2 and/or 100GBASE-T4 specification.

This provides the advantage that these standards are supported by the apparatus.

In an exemplary implementation of the apparatus, the multilane data transmitter is configured to transmit data according to IEEE 802.3cy standard.

According to current version of IEEE 802.3cy standard, data transmission may be based on a 33-bit data scrambler with a scrambler period of 613 milliseconds. It understands that later versions of this standard may support other polynomials than 33 bit, in particular higher than 33-bit, for example in the case when 33-bits may be realized to be too short.

This provides the advantage that this standard and later versions thereof are supported by the apparatus.

In an exemplary implementation of the apparatus, each data scrambler of the set of data scramblers comprises the same scrambler polynomial.

This provides the advantage that by using the same scrambler polynomial, the data scramblers operate in the same manner, only differing by their respective seed signals.

In an exemplary implementation of the apparatus, the apparatus comprises: a set of registers for storing the seed signals, each register being associated with a respective data scrambler of the set of data scramblers; and a control channel for receiving a control signal, the control signal being configured to initialize the linear feedback shift registers of the data scramblers with the corresponding seed signals stored in the set of registers upon initialization of the data transmission.

This provides the advantage that initialization of the data scramblers can be easily performed by using the control signal which triggers an initialization.

In an exemplary implementation of the apparatus, the first data scrambler is continuously running without going to sleep mode when the multilane data transmitter or a section of the multilane data transmitter associated with transmission over the first communication lane is going to sleep mode.

This provides the advantage that the first data scrambler maintains the same phase difference with respect to the other data scramblers as initialized in the beginning. Hence, no phase desynchronization can happen which would negatively affect the proper randomization between the communication lanes.

In an exemplary implementation of the apparatus, the first data scrambler is going to sleep mode upon reception of a sleep mode request; and wherein once a wake-up request is received, the apparatus is configured to determine actual states of all data scramblers and to determine the first seed signal based on the read states of all data scramblers and the predetermined signal distance measure.

This provides the advantage that the predetermined signal distance measure can be kept between the seed signals and thus the optimal randomization between the communication lanes can be maintained, also after one or more of the scramblers has been gone to sleep mode.

In an exemplary implementation of the apparatus, the apparatus comprises a controller configured to read the actual states of all data scramblers once the sleep mode request is received; and the controller is configured to determine the corresponding seed signals for the set of data scramblers based on the actual states of the data scramblers and the predetermined signal distance measure.

This provides the advantage that the controller can be easily used to maintain the predetermined signal distance measure between the seed signals after the wake-up request.

In an exemplary implementation of the apparatus, the controller is configured to determine the corresponding seed signals based on a number of cycles between reception of the sleep mode request and reception of the wake-up request.

This provides the advantage that the controller can easily reconstruct the initial states in order to maintain the predetermined signal distance measure between the seed signals after the wake-up request including a next seed write synchronization cycle to a polynomial of the corresponding data scrambler.

According to a second aspect, the disclosure relates to a method for increasing randomness among different communication lanes of a multilane wired data communication link, the method comprising: simultaneously transmitting data over a first communication lane and a second communication lane of the multilane wired data communication link; scrambling the data, by a set of data scramblers, wherein a first data scrambler of the set of data scramblers is assigned to scramble data for transmission over the first communication lane and wherein a second data scrambler of the set of data scramblers is assigned to scramble data for transmission over the second communication lane, wherein the first data scrambler scrambles the data starting with a first seed signal specifying an initial state of the first data scrambler, wherein the second data scrambler scrambles the data starting with a second seed signal specifying an initial state of the second data scrambler, wherein the first seed signal and the second seed signal differ from each other by a predetermined signal distance measure that increases the randomness among the data from the set of data scramblers.

Such a method provides the same advantages as the apparatus described above. I.e., the method allows to sufficiently increase randomness among the different communication lanes of the multilane wired data communication link. This means that crosstalk can be efficiently cancelled or at least significantly reduced at the receiver. This allows data transmission at higher data rates, since crosstalk is reduced, thereby not disturbing signal reconstruction at the receiver.

Such a method for increasing randomness among the different communication lanes helps to maximize the crosstalk mitigation at the receiver.

### BRIEF DESCRIPTION OF THE DRAWINGS

Further embodiments of the disclosure will be described with respect to the following figures, in which:

FIG. 1 shows a schematic diagram of a multilane wired data communication link 100 not applying the concept according to the disclosure;

FIG. 2 shows a block diagram of an apparatus 200 for increasing randomness among different communication lanes according to the disclosure;

FIG. 3 shows a schematic diagram illustrating an example of phase differences 300 among the data scramblers applied in an apparatus 200 as shown in FIG. 2;

FIG. 4 shows a schematic diagram illustrating initialization 400 of exemplary data scramblers 410, 420 applied in an apparatus 200 as shown in FIG. 2;

FIG. 5 shows a schematic diagram illustrating an example for initial states of the data scramblers 410, 420 shown in FIG. 4;

FIG. 6 shows a schematic diagram illustrating a method 600 for increasing randomness among different communication lanes according to the disclosure;

FIG. 7 shows a block diagram of the apparatus 200 shown in FIG. 2 in a normal operation mode 700a and in an Energy Efficient Ethernet (EEE) mode 700b according to a first EEE mode embodiment; and

FIG. 8 shows a block diagram of the apparatus 200 shown in FIG. 2 in an EEE mode according to a second EEE mode embodiment.

### DETAILED DESCRIPTION OF EMBODIMENTS

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the present disclosure. The following detailed description, therefore, is not to be taken in a limiting sense, and the scope of the present disclosure is defined by the appended claims.

It is understood that comments made in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

The devices described herein may be configured to transmit and/or receive data over wired communication lines, e.g., according to the IEEE 802.3, in particular IEEE 802.3cy or IEEE 802.3ch. Wired transmission lines according to 10GBASE-T1, 25GBASE-T1, 50GBASE-T2, 100GBASE-T4 and other specifications may be used.

In this disclosure a multilane wired data communication link comprising multiple communication lanes is described. Each communication lane is an individual communication link for data transmission. Such a communication lane may be a twisted pair line, for example, or a coaxial cable, for example or any other suitable design. The multiple communication lanes of the multilane wired data communication link may share a same reference line, e.g., have the same ground, or may include own reference lines, e.g., each communication lane may have its own ground, for example, or any combination thereof. Such a multilane wired data communication link can be utilized in high-speed communication, providing accurate and repeatable results. Such multilane wired data communication link can be designed to offer minimal attenuation and signal distortion, and to operate efficiently across the frequency band of interest.

In this disclosure, Energy Efficient Ethernet (EEE) mode is described. Energy Efficient Ethernet (EEE) mode is an optional mode of operation to enable low power when there is no need to transfer data between two link partners. In this scenario, one or more link partners out of two (for 50GBASE-T2) or out of four (100GBASE-T4) may request to go to “low power idle (LPI)” or “low power sleep” mode as there is nothing to transfer. When there is something to be transferred then one of the link partner will get “wake-up” message and the link will wake up again from idle to normal data transmission. In this scenario, when the link wakes up from “idle or deep sleep”, the disclosure presents a solution to make sure that scrambler seeds are still maintaining the same phase shift it was initialized before the link was enabled.

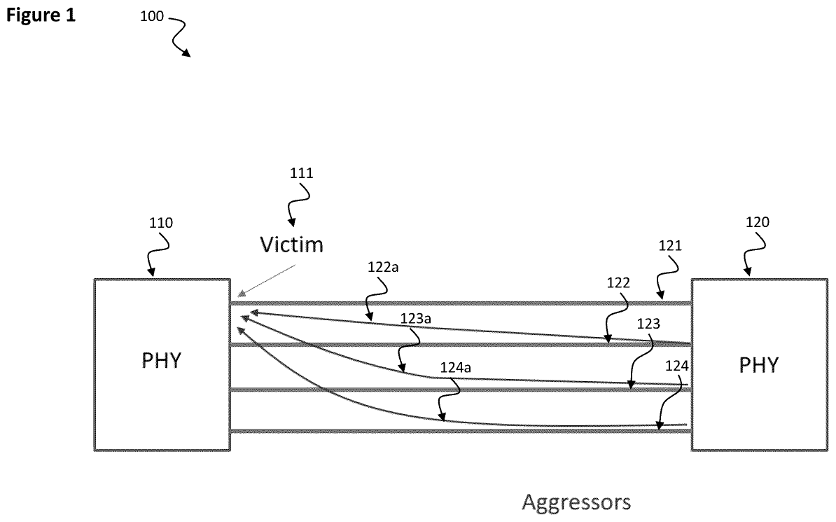

FIG. 1 shows a schematic diagram of a multilane wired data communication link 100 not applying the concept according to the disclosure. The multilane wired data communication link 100 has a number of four communication lanes 121, 122, 123, 124 transmitting data from one PHY 120 to another PHY 110 acting here as a receiver and victim 111 of crosstalk 122a, 123a, 124a from neighboring communication lanes 122, 123, 124.

All the existing technologies that are based on multilane communication use higher order polynomial scrambler in order to make sure that there is no data correlation among the lanes. This is important for cancelling the unavoidable crosstalk that happens among the lanes as illustrated in FIG. 1. Recently, in IEEE 802.3cy standard for automotive applications, a 33-bit scrambler with a scrambler period of 0.6 sec was adopted. The multilane PHY technology will deploy a maximum of four lanes 121, 122, 123, 124 to achieve 100 Gbit/s data rate and will duplicate the same 33-bit scrambler for all lanes.

Given the shorter scrambler period, the data stream from each lane will be correlated, as exemplarily illustrated in FIG. 1 for the first communication lane 121, since they are using the same 33-bits scrambler with relatively shorter scrambler period. In this situation with data streams which are highly correlated, it is virtually impossible to cancel the crosstalk at the receiver. Instead, extremely high order polynomial scrambler can be used to remove data correlation issue among the lanes. Earlier results, however, clearly illustrated that such higher order polynomial based scrambler results in poor emission behavior. Thus, it is an interest to keep the order of polynomial moderate and look for other options to improve the scrambler behavior that sufficiently randomizes the data stream among the lanes.

One other option for better randomization is presented hereinafter.

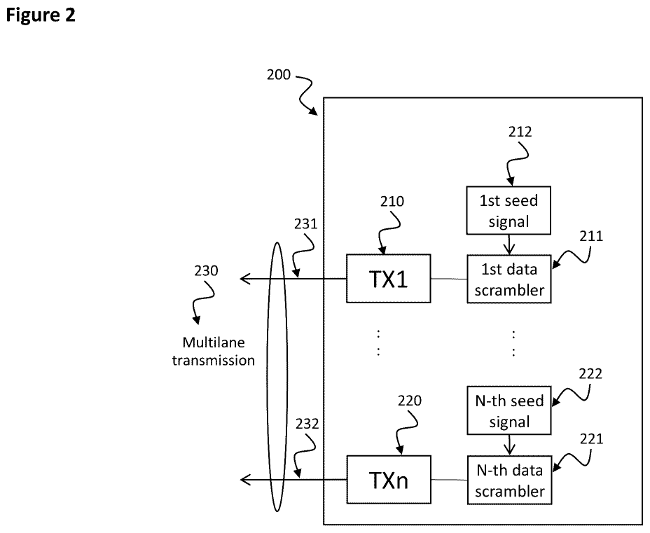

FIG. 2 shows a block diagram of an apparatus 200 for increasing randomness among different communication lanes 231, 232 of a multilane wired data communication link 230 according to the disclosure.

The apparatus 200 comprises a multilane data transmitter 210, 220 configured to simultaneously transmit data over a first communication lane 231 and a second communication lane 232 of the multilane wired data communication link 230.

The apparatus 200 comprises a set of data scramblers 211, 221 configured to scramble the data before transmission by the multilane data transmitter 210, 220. A first data scrambler 211 of the set of data scramblers 211, 221 is assigned to scramble data for transmission over the first communication lane 231. A second data scrambler 221 of the set of data scramblers 211, 221 is assigned to scramble data for transmission over the second communication lane 232.

The first data scrambler 211 is configured to scramble data starting with a first seed signal 212 specifying an initial state of the first data scrambler 211.

The second data scrambler 221 is configured to scramble data starting with a second seed signal 222 specifying an initial state of the second data scrambler 221.

The first seed signal 212 and the second seed signal 222 differ from each other by a predetermined signal distance measure. This predetermined signal distance measure is designed to increase the randomness among the data from the set of data scramblers.

The predetermined signal distance measure can be predetermined in such a way that it gives an optimal or maximum randomness among the data from the set of data scramblers.

Such an increase of randomness among the different communication lanes helps to maximize the crosstalk mitigation at the receiver.

The first seed signal 212 and the second seed signal 222 may be predefined based on the predetermined signal distance measure.

The signal distance measure may be predetermined in order to enable a data randomization among the communication lanes 231, 232 of the multilane data transmitter 210, 220, in order to minimize or at least reduce an effect of crosstalk 122a, 123a, 124a, as illustrated in FIG. 1, or/and if needed to mitigate crosstalk through cancellation at the receiver, e.g., at the PHY 110 as illustrated in FIG. 1.

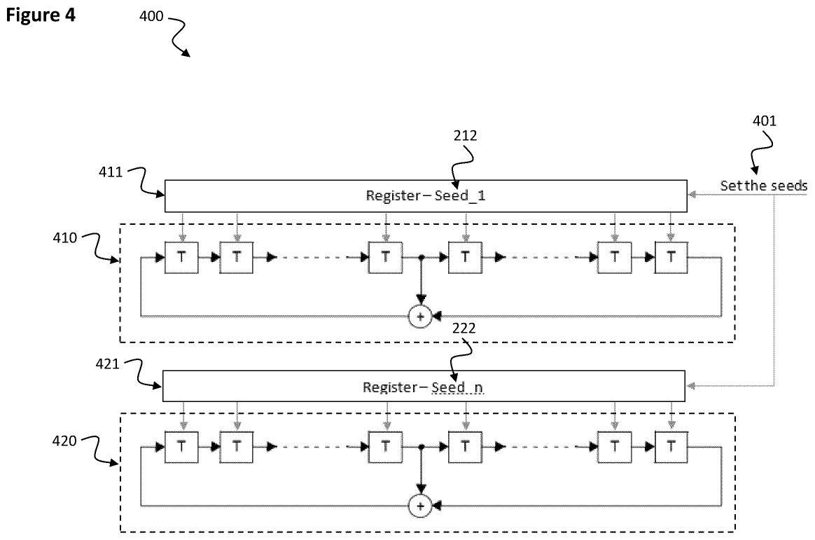

Each data scrambler of the set of data scramblers 211, 221 may comprises a linear feedback shift register 410, 420, as exemplarily shown in FIG. 4, and a scrambler polynomial defining an exclusive OR operation on the linear feedback shift register 410, 420. Each linear feedback shift register 410, 420 may be initialized by a corresponding seed signal 212, 222, before the multilane wired data communication link 230 is initialized, i.e. before the line is up.

For example, for 10GBASE-T, the master, e.g., transmitter, may use the polynomial: 1+X³⁹+X⁵⁸ and the slave, e.g., receiver, may use the polynomial: 1+X¹⁹+X⁵⁸. For 1000BASE-T1, the master may use the polynomial: 1+X⁴+X¹⁵ and the slave may use the polynomial: 1+X¹¹+X¹⁵. For 1000BASE-T, the master may use the polynomial: 1+X¹³+X³³ and the slave may use the polynomial: 1+X²⁰+X³³.

The first seed signal 212 may be associated with an initial state of a first linear feedback shift register 410 and the second seed signal 222 may be associated with an initial state of a second linear feedback shift register 420. The predetermined signal distance measure may be based on a Hamming distance, or any other metric, with respect to the initial states of the first linear feedback shift register 410 and the second linear feedback register 420.

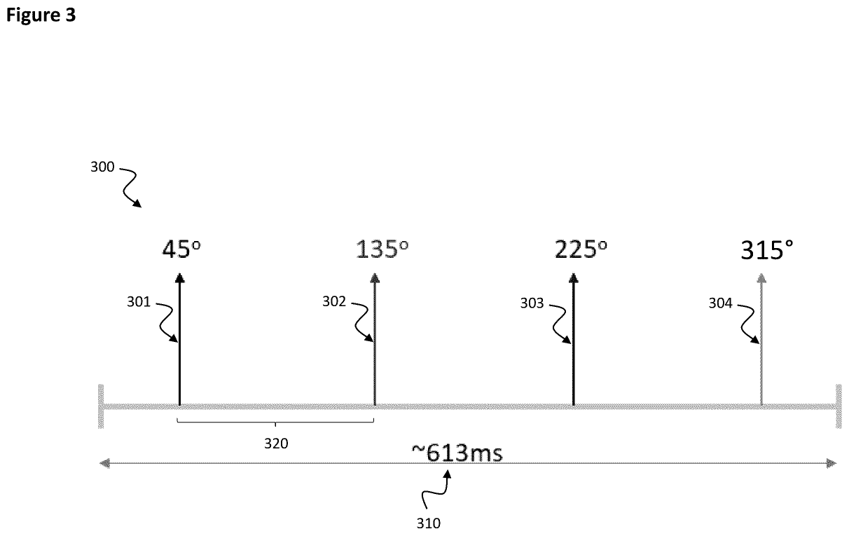

The first seed signal 212 and the second seed signal 222 may be designed to have different phases, e.g. as shown in FIG. 3. The phases may be predefined according to the predetermined signal distance measure.

The phase difference 320 between the first seed signal 212 and the second seed signal 222 may be based on a number of communication lanes 231, 232 of the multilane data transmitter 210, 220, e.g., as shown in FIG. 3 for an example of a 4-lane communication link. The phase difference 320 between the first seed signal 212 and the second seed signal 222 may lie within a threshold range around 360 degrees divided by the number of communication lanes 231, 232, as shown in FIG. 3. The 360 degrees correspond to a period 310 of the data scramblers 211, 221 of the set of data scramblers. In the example of FIG. 3, this period is 613 milliseconds.

In one exemplary implementation, a four-lane wired data communication link 230 may be utilized. Then, a first seed signal 301 of a first data scrambler 211 associated with a first communication lane of the four-lane data transmitter may correspond to a phase of 45 degrees or a phase within a threshold range around 45 degrees, as shown in FIG. 3. A second seed signal 302 of a second data scrambler 221 associated with a second communication lane of the four-lane data transmitter may corresponds to a phase of 135 degrees or a phase within a threshold range around 135 degrees, as shown in FIG. 3. A third seed signal 303 of a third data scrambler associated with a third communication lane of the four-lane data transmitter may correspond to a phase of 225 degrees or a phase within a threshold range around 225 degrees, as shown in FIG. 3. A fourth seed signal 304 of a fourth data scrambler associated with a fourth communication lane of the four-lane data transmitter may correspond to a phase of 315 degrees or a phase within a threshold range around 315 degrees, as illustrated in FIG. 3.

The above mentioned threshold range may be, for example, within +/−1°, +/−2°,+/−3°,+/−5°,+/−10°,+/−15°,+/−20°,+/−25°,+/−30° around the corresponding phase. It understands that other suitable ranges and also non-symmetrical ranges can be applied as well.

In another exemplary implementation, a two-lane wired data communication link 230 may be utilized. In this implementation, a first seed signal of a first data scrambler 211 associated with a first communication lane of the two-lane data transmitter may correspond to a phase of 90 degrees or a phase within a threshold range around 90 degrees. A second seed signal of a second data scrambler 221 associated with a second communication lane of the two-lane data transmitter corresponds to a phase of 270 degrees or a phase within a threshold range around 270 degrees.

The above mentioned threshold range may be, for example, within +/−1°, +/−2°, +/−3°,+/−5°,+/−10°,+/−15°,+/−20°,+/−25°,+/−30°,+/−35°,+/−40°,+/−50°,+/−60° around the corresponding phase. It understands that other suitable ranges and also non-symmetrical ranges can be applied as well.

Such a two-lane wired data communication link 230 may also be defined according to the example of FIG. 3 in which the seed signals corresponding to the phases 135 degrees and 315 degrees are removed. Then, the first seed signal may correspond to a phase of 45 degrees and the second seed signal may correspond to a phase of 225 degrees, both of them being separated by 180 degrees.

The set of data scramblers 211, 221 may be configured to decorrelate the data of the different communication lanes 231, 232 of the multilane wired data communication link 230.

The set of data scramblers 211, 221 may comprise self-synchronizing data scramblers which are configured to scramble the data without knowledge of a frame synchronization of the data.

Self-synchronizing scramblers are multiplicative scramblers (also known as feed-through) that perform a multiplication of the input signal by the scrambler's transfer function in Z-space, e.g., as shown in FIG. 4. They are discrete linear time-invariant systems. A multiplicative scrambler is recursive, and a multiplicative descrambler is non-recursive. Unlike additive scramblers, multiplicative scramblers do not need the frame synchronization, that is why they are also called self-synchronizing. Multiplicative scrambler/descrambler is defined similarly by a polynomial, which is also a transfer function of the descrambler.

In one exemplary implementation, the multilane data transmitter 210, 220 may be configured to transmit data according to 50GBASE-T2 and/or 100GBASE-T4 specification.

In one exemplary implementation, the multilane data transmitter 210, 220 may be configured to transmit data according to IEEE 802.3cy standard.

According to current version of IEEE 802.3cy standard, data transmission may be based on a 33-bit data scrambler with a scrambler period of 613 milliseconds. It understands that later versions of this standard may support other polynomials than 33 bit, in particular higher than 33-bit, for example in the case when 33-bits may be realized to be too short.

Each data scrambler of the set of data scramblers 211, 221 may comprise the same scrambler polynomial.

The apparatus 200 may further comprise: a set of registers 411, 421, e.g., as shown in FIG. 4, for storing the seed signals 212, 222. Each register may be associated with a respective data scrambler of the set of data scramblers 211, 221.

The apparatus 200 may comprise a control channel for receiving a control signal 401, e.g., as shown in FIG. 4. The control signal 401 may be configured to initialize the linear feedback shift registers 410, 420 of the data scramblers 211, 221 with the corresponding seed signals 212, 222 stored in the set of registers 411, 421 upon initialization of the data transmission 230.

FIG. 3 shows a schematic diagram illustrating an example of phase differences 300 among the data scramblers applied in an apparatus 200 as shown in FIG. 2.

The example of FIG. 3 illustrates a four-lane wired data communication link 230. A first seed signal 301 of a first data scrambler 211, e.g., as shown in FIG. 2, associated with a first communication lane 231 of the four-lane data transmitter may correspond to a phase of 45 degrees or a phase within a threshold range around 45 degrees. Such a threshold range may be, for example, within +/−1°, +/−2°,+/−3°,+/−5°,+/−10°,+/−15°,+/−20°,+/−25°,+/−30° around the phase of 45°.

A second seed signal 302 of a second data scrambler 221, e.g., as shown in FIG. 2, associated with a second communication lane 232 of the four-lane data transmitter may corresponds to a phase of 135 degrees or a phase within a threshold range around 135 degrees. Such a threshold range may be, for example, within +/−1°, +/−2°,+/−3°,+/−5°,+/−10°,+/−15°,+/−20°,+/−25°,+/−30° around the phase of 135°.

A third seed signal 303 of a third data scrambler associated with a third communication lane of the four-lane data transmitter may correspond to a phase of 225 degrees or a phase within a threshold range around 225 degrees. Such a threshold range may be, for example, within +/−1°, +/−2°,+/−3°,+/−5°,+/−10°,+/−15°,+/−20°,+/−25°,+/−30° around the phase of 225°.

A fourth seed signal 304 of a fourth data scrambler associated with a fourth communication lane of the four-lane data transmitter may correspond to a phase of 315 degrees or a phase within a threshold range around 315 degrees, as illustrated in FIG. 3. Such a threshold range may be, for example, within +/−1°, +/−2°,+/−3°,+/−5°,+/−10°,+/−15°,+/−20°,+/−25°,+/−30° around the phase of 315°.

Each of the seed signals have a phase difference 320 of 90° in this example of a four-lane wired data communication link 230.

FIG. 3 shows that it is very important to maintain the sufficient randomization of data stream among multiple lanes in order to eliminate the crosstalk noise at the receiver. However, a relatively low order scrambler polynomial cannot guarantee this for all scenarios. Thus, the disclosed scrambler seeds initialization technique as exemplarily shown for the four-lane wired data communication link 230 of FIG. 3 should be applied to make sure that those seeds have a sufficient distance with respect to each other (“are sitting far apart”) and the resulting data streams from those scramblers are sufficiently randomized. This initialization may be performed at the beginning of link start-up so that the phase difference among the scramblers can be maintained all the time.

FIG. 4 shows a schematic diagram illustrating initialization 400 of exemplary data scramblers 410, 420 applied in an apparatus 200 as shown in FIG. 2.

The FIG. 4 shows a scrambler 410, 420, which is a linear feedback shift register. Depending on the definition of the scrambler polynomial, an exclusive OR operation is accordingly performed. Further depending on the number of lanes available for a certain wired based communication technology, initialization 401 of seeds, i.e., the seed signals 212, 222 described above with respect to FIG. 2, for a corresponding scrambler 410, 420 is predetermined and stored in registers 411, 421. Every time before the communication link is up, the content of register 411, 421 is loaded to the corresponding scrambler 410, 420. If needed, a test can be carried out to make sure that a set of scramblers is generating sufficiently random data.

The phase difference among the seeds 212, 222 of scrambler 410, 420 depends on the number of lanes. For example, a phase difference corresponding to 360/number of lanes may be applied.

In one embodiment, phase separation among the seeds is ideal. For example for wired based communication technology with four lanes, scrambler seeds are exactly 90 degree apart. Depending on the phase separation, seeds content will be calculated and stored in the registers 411, 421.

Such phase separation results in excellent randomization of data from the set of scramblers 410, 420.

In another embodiment, phase separation among the seeds can be slightly different from the ideal value. For instance, in case of four lanes based wired communication technology, an ideal phase difference is 90 degrees, however, due to practical reasons, the phase difference between scramblers can be slightly less than 90 degrees or slightly more than 90 degrees.

The size of scrambler polynomial is not limited to a certain number. A technique that evaluates scrambler seeds separation in terms of phase (degree) or distance (milliseconds) and their corresponding content for each scrambler may be applied that gives sufficiently random data at the output of scramblers.

Such phase separation results in sufficient randomization of data from the set of scramblers 410, 420.

In other embodiments, scrambler seeds phase difference or distance separation in millisecond can be varied (changed) to some extend until the random behavior among the scrambler's 410, 420 output starts to get poor.

Even such phase separation still results in sufficient randomization of data from the set of scramblers 410, 420.

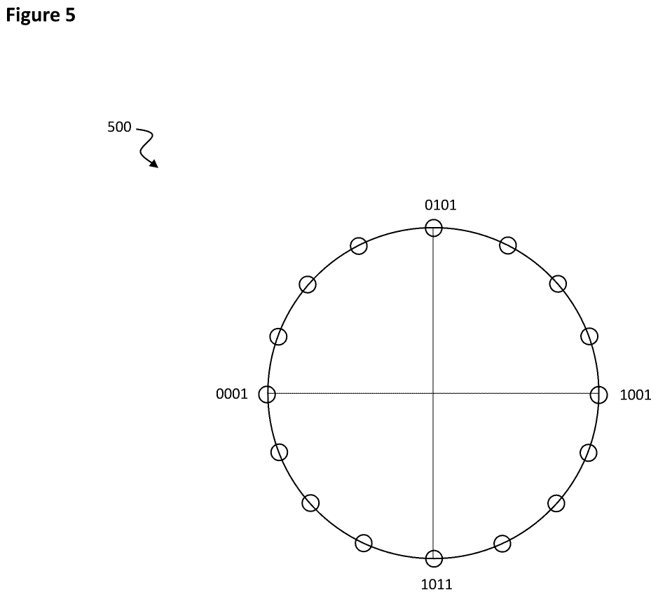

FIG. 5 shows a schematic diagram illustrating an example for initial states of the data scramblers 410, 420 shown in FIG. 4.

In a four-lane communication link, a first seed signal, e.g. a seed signal 212 as shown in FIG. 2, may be associated with an initial state of a first linear feedback shift register 410, e.g., as shown in FIG. 4. The initial state of the first linear feedback shift register 410 may be “0001”, for example, as shown in FIG. 5. A second seed signal may be associated with an initial state of a second linear feedback shift register. The initial state of the second linear feedback shift register may be “0101”, for example, as shown in FIG. 5. A third seed signal may be associated with an initial state of a third linear feedback shift register. The initial state of the third linear feedback shift register may be “1001”, for example, as shown in FIG. 5. A fourth seed signal may be associated with an initial state of a fourth linear feedback shift register. The initial state of the fourth linear feedback shift register may be “1011”, for example, as shown in FIG. 5.

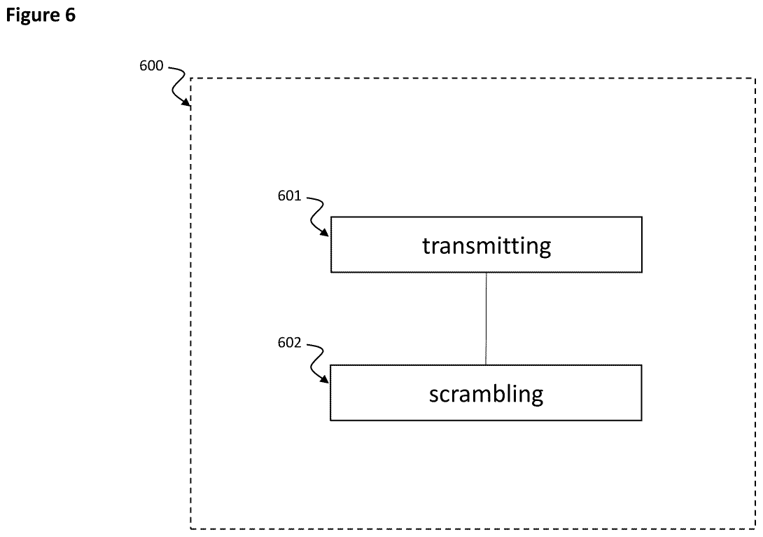

FIG. 6 shows a schematic diagram illustrating a method 600 for increasing randomness among different communication lanes of a multilane wired data communication link 230, e.g., as shown in FIG. 2, according to the disclosure.

The method 600 comprises: simultaneously transmitting 601 data over a first communication lane 231 and a second communication lane 232 of the multilane wired data communication link, e.g., as described above with respect to FIG. 2.

The method 600 comprises: scrambling 602 the data, by a set of data scramblers, wherein a first data scrambler 211 of the set of data scramblers 211, 221 is assigned to scramble data for transmission over the first communication lane 231 and wherein a second data scrambler 221 of the set of data scramblers 211, 221 is assigned to scramble data for transmission over the second communication lane 232, e.g., as described above with respect to FIG. 2, wherein the first data scrambler 211 scrambles the data starting with a first seed signal 212 specifying an initial state of the first data scrambler 211, wherein the second data scrambler 221 scrambles the data starting with a second seed signal 222 specifying an initial state of the second data scrambler 221, wherein the first seed signal 212 and the second seed signal 222 differ from each other by a predetermined signal distance measure that increases the randomness among the data from the set of data scramblers.

Such a method for increasing randomness among the different communication lanes helps to maximize the crosstalk mitigation at the receiver.

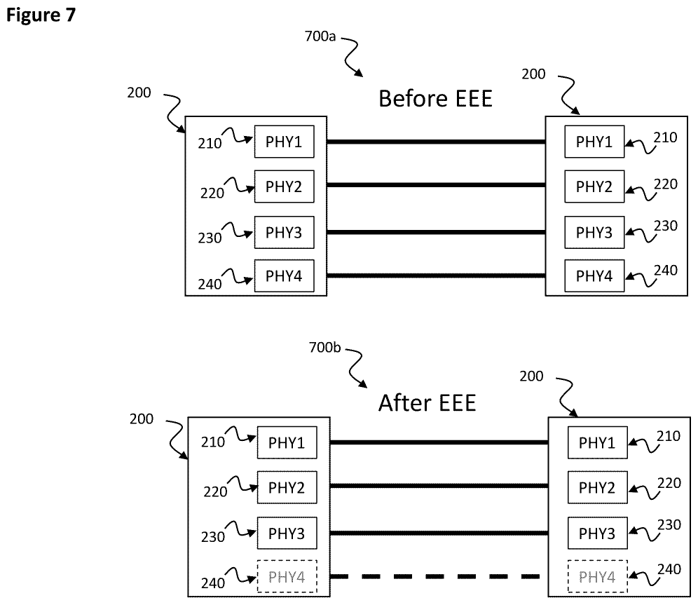

FIG. 7 shows a block diagram of the apparatus 200 shown in FIG. 2 in a normal operation mode 700a and in an Energy Efficient Ethernet (EEE) mode 700b according to a first embodiment.

In the upper diagram, a multilane wired data communication link is shown in a normal operation mode 700a between two apparatus 200 as shown in FIG. 2. Each communication lane 231, 232, 233, 234 between two respective PHYs 210, 220, 230, 240 is up, i.e., operating in normal mode.

In the lower diagram, the multilane wired data communication link is shown in EEE mode 700b. In this example, the fourth communication lane 234 is going to sleep, i.e., in EEE mode while the other communication lanes 231, 232, 233 are still in power up, i.e., operating in a normal operation mode.

This represents only one example of EEE mode. In other examples, the first communication lane 231 may be in sleep mode while the other communication lanes 232, 233, 234 may be in sleep mode or idle mode, i.e., in EEE mode. Any combination of power-up and sleep or idle mode for the different communication lanes may be possible, e.g., three communication lanes in sleep or idle mode and one communication lane in power-up or normal mode or two communication lanes in sleep or idle mode and the other two communication lanes in power-up or normal mode.

With respect to the upper diagram, all four PHYs 210, 220, 230, 240 went through start-up process by initializing the seeds of scrambler that are sufficiently far apart to maintain a good data randomization among the lanes, e.g., as described above with respect to FIG. 2. Right after the link carried out normal data transmission, one of the link partner or more than one link partner receive “low power sleep” or “low power idle” mode. This gets communicated to its link partner(s) at the other end and that particular link goes to low power idle or low power sleep mode as shown in the lower diagram of FIG. 7.

After certain time interval, one of the link partner(s) may receive wake-up message which will be communicated to other partner(s). Once the slept or idle PHY goes to normal data mode, the scrambler seeds should maintain the same phase difference as it was initialized at the beginning. The disclosure presents two embodiments of the apparatus 200 described above with respect to FIG. 2 to keep the same phase difference as it was initialized at the beginning after going to normal data mode.

According to the first embodiment shown in FIG. 7, during low power idle or low power sleep mode, the data scrambler must not go to sleep mode.

Though a PHY or a set of PHYs are in sleep mode or idle mode, its or their data scramblers 211, 221 (see FIG. 2) must be continuously running in order to maintain the same phase difference among the data scramblers 211, 221.

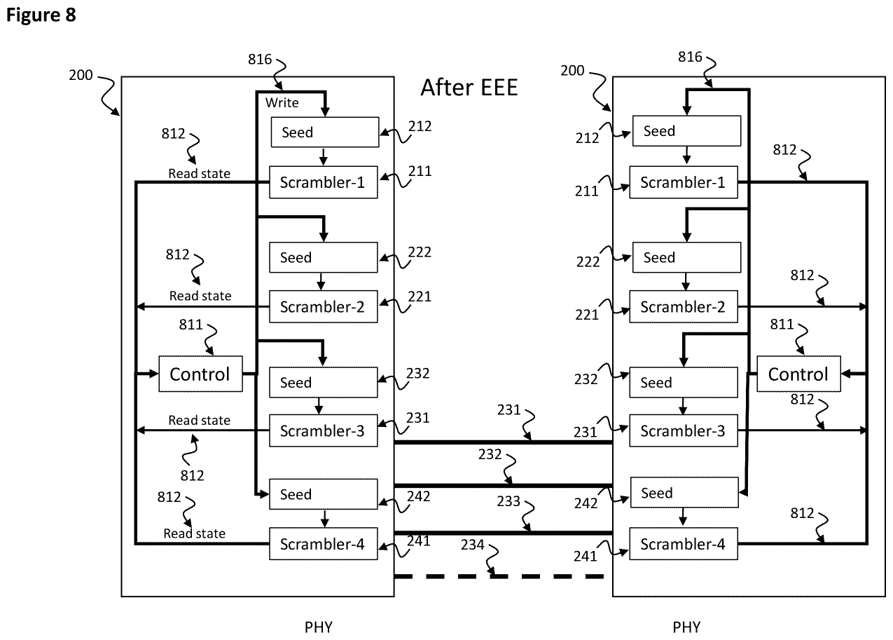

FIG. 8 shows a block diagram of the apparatus 200 shown in FIG. 2 in an EEE mode according to a second embodiment.

FIG. 8 depicts a multilane wired data communication link between two apparatus 200 as shown in FIG. 2 in an EEE mode according to a second embodiment. In this example, the fourth communication lane 234 is going to sleep, i.e., in EEE mode while the other communication lanes 231, 232, 233 are still in power up, i.e., operating in a normal operation mode.

In this second embodiment, during low power idle or low power sleep mode, data scrambler will go to sleep mode.

Once a PHY receives wake-up request, all scrambler states are read and corresponding required phase differences are computed only for the PHYs that were in idle or sleep mode. Corresponding seeds, i.e., seed signals 212, 222 according to FIG. 2, are once again initialized for those PHYs that were gone for “idle” or “sleep”.

Once the seeds are reinitialized then only those PHYs and corresponding link partners will go to training or full data transmission.

In the following, an exemplary functionality of the apparatus 200 is described.

In the apparatus 200, the first data scrambler 211 may be going to sleep mode upon reception of a sleep mode request. Once, a wake-up request is received, the apparatus 200 may be configured to determine actual states of all data scramblers and to determine the first seed signal 212 based on the read states of all data scramblers and the predetermined signal distance measure.

The apparatus 200 may comprise a controller 811 that may be configured to read the actual states 812 of all data scramblers 211, 221, 231, 241 once the sleep mode request is received. The controller 811 may be configured to determine the corresponding seed signals 212, 222, 232, 242 for the set of data scramblers based on the actual states 812 of the data scramblers 211, 221, 231, 241 and the predetermined signal distance measure.

The controller 811 may be configured to determine the corresponding seed signals 212, 222, 232, 242 based on a number of cycles between reception of the sleep mode request and reception of the wake-up request including a next seed write synchronization cycle to a scrambler polynomial of the corresponding data scrambler 211, 221, 231, 241, e.g., a scrambler polynomial as described above with respect to FIG. 4.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the disclosure beyond those described herein. While the present disclosure has been described with reference to one or more particular embodiments, those skilled in the art recognize that many changes may be made thereto without departing from the scope of the present disclosure. It is therefore to be understood that within the scope of the appended claims and their equivalents, the disclosure may be practiced otherwise than as specifically described herein.

What is claimed is:

1. An apparatus for increasing randomness among different communication lanes of a multilane wired data communication link, the apparatus comprising:
a multilane data transmitter configured to simultaneously transmit data over a first communication lane of the multilane wired data communication link and a second communication lane of the multilane wired data communication link; and
a set of data scramblers configured to scramble the data before transmission by the multilane data transmitter, wherein a first data scrambler of the set of data scramblers is assigned to scramble data for transmission over the first communication lane and a second data scrambler of the set of data scramblers is assigned to scramble data for transmission over the second communication lane;
wherein the first data scrambler is configured to scramble data starting with a first seed signal specifying an initial state of the first data scrambler,
wherein the second data scrambler is configured to scramble data starting with a second seed signal specifying an initial state of the second data scrambler,
wherein the first seed signal and the second seed signal differ from each other by a predetermined signal distance measure that increases the randomness among the data from the set of data scramblers.

2. The apparatus of claim 1, wherein the first seed signal and the second seed signal are predefined based on the predetermined signal distance measure.

3. The apparatus of claim 1, wherein the signal distance measure is predetermined in order to enable a data randomization among the communication lanes of the multilane data transmitter in order to reduce an effect of crosstalk and/or mitigate crosstalk through cancellation at a receiver.

4. The apparatus of claim 1, wherein each data scrambler of the set of data scramblers comprises a linear feedback shift register and a scrambler polynomial defining an exclusive OR operation on the linear feedback shift register, and
wherein each linear feedback shift register is initialized by a corresponding seed signal before the multilane wired data communication link is initialized.

5. The apparatus of claim 4, wherein the first seed signal is associated with an initial state of a first linear feedback shift register and the second seed signal is associated with an initial state of a second linear feedback shift register,
wherein the predetermined signal distance measure is based on a Hamming distance with respect to the initial states of the first linear feedback shift register and the second linear feedback register.

6. The apparatus of claim 1, wherein the first seed signal and the second seed signal have different respective phases, the respective phases being predefined according to the predetermined signal distance measure.

7. The apparatus of claim 6, wherein the phase difference between the first seed signal and the second seed signal is based on a number of communication lanes of the multilane data transmitter.

8. The apparatus of claim 7, wherein the phase difference between the first seed signal and the second seed signal lies within a threshold range of 360 degrees divided by the number of communication lanes,
wherein the 360 degrees correspond to a period of the data scramblers of the set of data scramblers.

9. The apparatus of claim 1, wherein the multilane wired data communication link is a four-lane wired data communication link,
wherein a first seed signal of a first data scrambler associated with a first communication lane of the four-lane data transmitter corresponds to a phase of 45 degrees,
a second seed signal of a second data scrambler associated with a second communication lane of the four-lane data transmitter corresponds to a phase of 135 degrees,
a third seed signal of a third data scrambler associated with a third communication lane of the four-lane data transmitter corresponds to a phase of 225 degrees, and
a fourth seed signal of a fourth data scrambler associated with a fourth communication lane of the four-lane data transmitter corresponds to a phase of 315 degrees.

10. The apparatus of claim 1, wherein the multilane wired data communication link is a two-lane wired data communication link,
a first seed signal of a first data scrambler associated with a first communication lane of the two-lane data transmitter corresponds to a phase of 90 degrees, and
a second seed signal of a second data scrambler associated with a second communication lane of the two-lane data transmitter corresponds to a phase of 270 degrees.

11. The apparatus of claim 1, wherein the set of data scramblers is configured to decorrelate the data of the different communication lanes of the multilane wired data communication link.

12. The apparatus of claim 1, wherein the set of data scramblers comprises self-synchronizing data scramblers which are configured to scramble the data without knowledge of a frame synchronization of the data.

13. The apparatus of claim 1, wherein the multilane data transmitter is configured to transmit data according to 50GBASE-T2 and/or 100GBASE-T4 specification.

14. The apparatus of claim 1, wherein the multilane data transmitter is configured to transmit data according to IEEE 802.3cy standard.

15. The apparatus of claim 4, wherein each data scrambler of the set of data scramblers comprises the same scrambler polynomial.

16. The apparatus of claim 15, further comprising:
a set of registers for storing the seed signals, each register being associated with a respective data scrambler of the set of data scramblers; and
a control channel for receiving a control signal, the control signal being configured to initialize the linear feedback shift registers of the data scramblers with the corresponding seed signals stored in the set of registers upon initialization of the data transmission.

17. The apparatus of claim 1, wherein the first data scrambler is configured to continuously run without going to sleep mode when the multilane data transmitter or a section of the multilane data transmitter associated with transmission over the first communication lane is in sleep mode.

18. The apparatus of claim 1, wherein the first data scrambler is configured to go to sleep mode upon reception of a sleep mode request; and
wherein, once a wake-up request is received, the apparatus is configured to determine actual states of all data scramblers and to determine the first seed signal based on the read states of all data scramblers and the predetermined signal distance measure.

19. The apparatus of claim 18, further comprising a controller configured to read the actual states of all data scramblers once the sleep mode request is received; and
wherein the controller is configured to determine the corresponding seed signals for the set of data scramblers based on the actual states of the data scramblers and the predetermined signal distance measure.

20. The apparatus of claim 19, wherein the controller is further configured to determine the corresponding seed signals based on a number of cycles between reception of the sleep mode request and reception of the wake-up request including a next seed write synchronization cycle to a scrambler polynomial of the corresponding data scrambler.

21. A method for increasing randomness among different communication lanes of a multilane wired data communication link, the method comprising:
simultaneously transmitting data over a first communication lane of the multilane wired data communication link and a second communication lane of the multilane wired data communication link;
scrambling, by a first data scrambler of a set of data scramblers, data for transmission over the first communication lane; and
scrambling, by a second data scrambler of the set of data scramblers, data for transmission over the second communication lane,
wherein the first data scrambler scrambles the data starting with a first seed signal specifying an initial state of the first data scrambler,
wherein the second data scrambler scrambles the data starting with a second seed signal specifying an initial state of the second data scrambler, and
wherein the first seed signal and the second seed signal differ from each other by a predetermined signal distance measure that increases the randomness among the data from the set of data scramblers.
